(19) United States
(12) Patent Application Publication
(10) Pub. No.: US 2009/0201567 A1
(43) Pub. Date: Aug. 13, 2009

(54) OPTICAL FILTER DEVICE AND METHOD OF REDUCING VIGNETTING

(75) Inventor: Christoph Dobrusskin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,749

(22) PCT Filed: Aug. 28, 2007
(86) PCT No.: PCT/IB2007/053453

§ 371 Date: Feb. 25, 2009

(30) Foreign Application Priority Data
Aug. 31, 2006 (EP) 06119853.7

(51) Int. Cl. G02B 26/02; G02B 1/06

(52) U.S. Cl. 359/291; 359/290

(57) ABSTRACT

An optical filter device (10) comprises a translucent medium (14) in which a light-blocking material is dissolved for filtering incident light. The optical filter has an optical axis (16) extending through the translucent medium. The translucent medium has a thickness distribution substantially parallel to the optical axis. The thickness distribution determines a length of an optical path through the optical filter device at different positions of the optical filter device. The length of an optical path determines a transmissivity. The optical filter device further comprises a control means (26, 32) for controlling the thickness distribution of the medium in order to control a transmissivity distribution of the optical filter device.

### FIELD OF THE INVENTION

The present invention relates to a method of reducing vignetting occurring in optical systems and to an optical device for reducing vignetting.

### BACKGROUND OF THE INVENTION

Optical systems exhibit vignetting. Vignetting results in a different amount of light being transmitted at the outer edges of a lens compared to the center of the lens. Thus, vignetting influences an image formed by the lens. This is in particular a problem in apparatus like a camera.

Vignetting may result due to optical principles and is therefore inherent to an optical system (hereinafter referred to as natural vignetting). Vignetting may as well of an artificial nature, e.g. due to mounting of an optical element such as a lens. Artificial vignetting may be reduced by use of a small aperture.

It is known in the art to reduce vignetting by applying a neutral density center-filter. Such a neutral density center filter has different transmission characteristics at the outer edges compared to the center such that the vignetting is reduced. The filter is however not suitable to accommodate for changes in the vignetting which may result from e.g. aperture changes, changes in the optical system for example due to zooming, or the like.

It is desirable to have an optical device that is suited to overcome the above-mentioned disadvantages. Therefore, it is an object of the present invention to provide a method and an optical filter device suitable for reducing vignetting and which is suitable for accommodating for changes in an optical system.

### SUMMARY OF THE INVENTION

In an aspect the present invention provides an optical device according to claim 1. The optical device comprises a medium that is translucent. In the translucent medium a light blocking material is dissolved. The light blocking material blocks at least a part of light incident on the optical filter device. The amount of light blocked depends on an optical path through the medium of the optical filter device. If the optical path is short, a small amount of light is blocked; if the optical path is long, a large amount of light is blocked. The optical path depends on a thickness of the medium of the optical filter device. In the present application, the thickness of the medium is defined as a dimension of the medium in a direction substantially parallel to an optical axis, which extends through the optical filter device. The thickness of the medium may vary over a surface of the optical filter device, which surface is substantially perpendicular to the optical axis. Therefore, hereinafter, there may be referred to a thickness distribution of the medium. The thickness distribution of the medium determines a transmissivity distribution of the optical filter device. In order to control the transmissivity distribution control means are provided for controlling the thickness distribution of the medium.

In an embodiment, the light blocking material may be a light absorbing material such as a material selected from the group comprising a dye and a pigment. In another embodiment, the light blocking material may be a light reflecting material, such as reflecting mica flakes. The light blocking material may as well be a combination of light absorbing and light reflecting materials. The light blocking material may block light having any wavelength or may block only a part of the light spectrum. The light blocking material may block visible light and/or may block non-visible light, such as infrared radiation and ultraviolet radiation.

In an embodiment the control means comprises an electrode for controlling the thickness using electrowetting. In another embodiment the translucent medium is held in an at least partly translucent container. The container has an opening, which opening is covered with an at least partly translucent elastic material. The control means comprises a pump for controlling an amount of the translucent medium in the container. In other embodiments, the control means may use magnetic force or piezoelectric forces, or any other suitable technique for controlling the thickness distribution.

In an embodiment the optical filter device comprises a first translucent medium having a light-absorbing material dissolved therein and a second translucent medium, the first and the second translucent medium being held in an at least partly translucent container, and wherein the control means comprises means for controlling a shape of a meniscus formed between the first and the second translucent medium. The optical path through the first translucent medium determines the transmissivity of the optical filter device. The second translucent medium fills the container. By controlling a shape of the meniscus between the first and the second translucent medium the thickness distribution of the first translucent medium is controlled and thereby the transmissivity distribution of the optical filter device. If the first and the second translucent medium have a substantially same refractive index, the shape of the meniscus does not influence the direction of the passing light. Thus, the optical filter device does not have a lens effect, but only a filtering effect.

In a further aspect of the present invention, a method according to claim 9 is provided. The method reduces the vignetting in optical systems. An optical filter device according to the present invention is employed to filter more light near a center of the filter device and filter less light near an outer perimeter of the filter device such that an even light distribution is provided after filtering by the optical filter device.

It is noted that the optical filter device according to the present invention is also suitable for other kind of filtering, for example correcting other optical effects and/or creating specific light effects. Further, the optical filter device may have any kind of shape in the above-mentioned surface perpendicular to the optical axis, such as round, square, and the like, or any arbitrary shape.

### BRIEF DESCRIPTION OF THE DRAWINGS

Hereinafter, the present invention is elucidated in more detail with reference to the appended drawing showing non-limiting embodiments, wherein

FIG. 1 shows a cross-section of a first embodiment of an optical filter device according to the present invention;

FIG. 2 shows a cross-section of a second embodiment of an optical filter device according to the present invention;

FIG. 3A-3C show a cross-section of a third embodiment of an optical filter device according to the present invention having a first, a second and a third transmissivity distribution, respectively; and

FIG. 4A-4C show the first, second and third transmissivity distributions of the embodiment shown in FIG. 3A-3C, respectively.

### DETAILED DESCRIPTION OF EXAMPLES

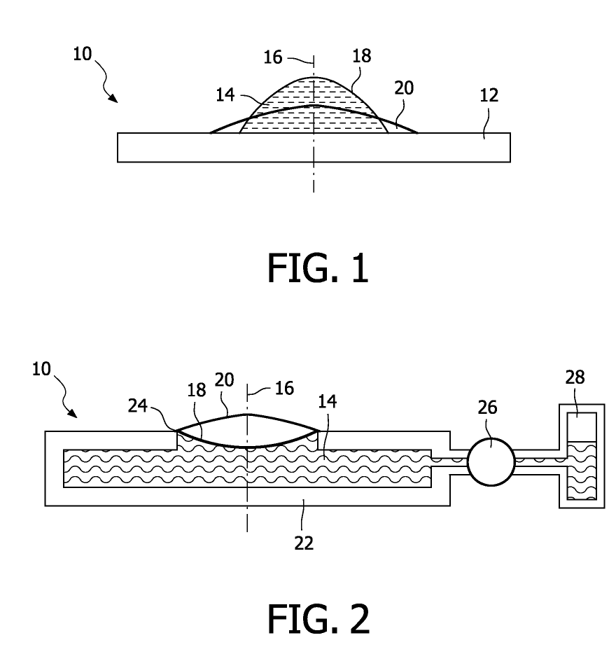

In the drawing, like reference numerals refer to like components and/or features. FIG. 1 schematically shows a first embodiment of an optical filter device 10 according to the present invention. The optical filter device 10 comprises a translucent substrate 12 on which a translucent medium 14 is arranged. In the translucent medium a light blocking material such as a dye, a pigment or a reflecting material is dissolved. An optical axis 16 extends through the medium 14. A meniscus 18 is formed over the medium 14. A thickness of the medium 14, i.e. a dimension substantially parallel to the optical axis 16, is at a maximum at the optical axis 16 and is reduced with an increasing distance from the optical axis 16. When light is incident on the optical filter device 10, a large amount of light passing near the optical axis 16 is absorbed or reflected, and thereby filtered, whereas only a small amount of light passing near the outer perimeter of the optical filter device 10 is absorbed or reflected. It is noted that due to the shape of the medium 14, in particular the shape of the meniscus 18, the light passing the optical filter device 10 is not only filtered, but the optical filter device 10 will as well have a lens effect on the light.

According to the invention, the thickness distribution of the medium 14 may be controlled in order to control a transmissivity distribution of the optical filter device 10. Using a suitable technique such as electrowetting, or any other technique, as will be apparent to those skilled in the art, the meniscus 18 may be altered, thereby changing the shape of the meniscus 18 into e.g. the meniscus shape 20. Compared to the meniscus having the shape 18, when the meniscus has the shape 20, the thickness distribution of the medium 14 is such that less light is blocked near the optical axis 16 and more light is blocked near the perimeter of the optical filter device 10.

FIG. 2 shows another embodiment of an optical filter device 10 according to the present invention. The optical filter device 10 comprises a container 22, in which an opening 24 is provided. An optical axis 16 extends through the container 22. Therefore, the container 22 is translucent at least near the optical axis 16. The opening 24 is covered with a translucent elastic meniscus 18. The container 22 is filled with a medium 14 in which a light blocking material is dissolved. A pump device 26 is provided to pump the medium 14 from the container 22 to a reservoir 28, or from the reservoir 28 to the container 22.

By controlling the shape of the meniscus 18, the thickness distribution of the medium 14 near the opening 24 of the container 22 is controllable. By supplying medium 14 from the reservoir 28 to the container 22, the meniscus 18 will obtain a different shape, such as the shape 20. Thus, the transmissivity distribution for light passing through the meniscus 18 may be controlled and adjusted as desired.

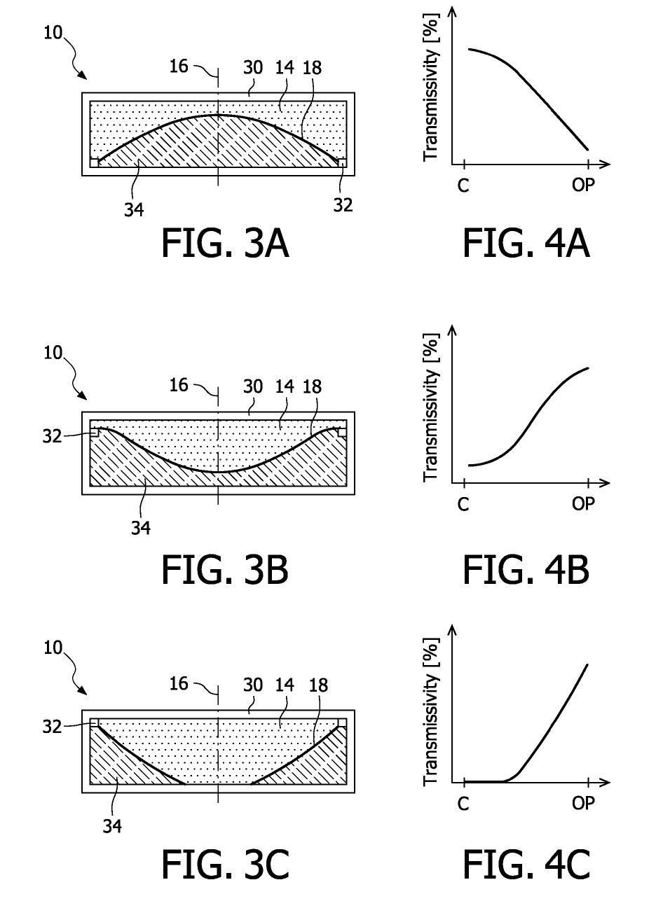

FIG. 3A-3C shows a further embodiment of an optical filter device 10 according to the present invention. The optical filter device 10 comprises a container 30 through which an optical axis 16 extends. The container 30 holds a first translucent medium 14 having light blocking material dissolved therein. The container 30 further holds a second translucent medium 34. The first and the second translucent medium 14, 34 together fill the container 30. A meniscus 18 is formed between the first and the second medium 14, 34. The perimeter of the meniscus 18 is coupled to a meniscus control element 32. The meniscus control element 32 is moveable in a direction substantially parallel to the optical axis 16. The meniscus control element 32 may be moved using any suitable technique, for example using a magnetic force and/or a piezoelectric force. As the volume of the first translucent medium and the volume of the second translucent medium cannot change, the position of the meniscus control element 32 determines the shape of the meniscus 18. The shape of the meniscus 18 determines the distribution of the first and the second medium 14, 34 in the container 30, as illustrated by the first, the second and the third position of the meniscus control element 32 in FIG. 3A, FIG. 3B and FIG. 3C, respectively. The first, second and third position of the meniscus 18 results in a corresponding first, second and third transmissivity distribution, respectively.

FIG. 4A-4C illustrate the first, second and third transmissivity distributions, respectively, corresponding to the first, second and third position of the meniscus 18 in FIG. 3A-3C, respectively. In FIG. 4A-4C a transmissivity plot is shown. Along the horizontal axis, a position in a plane perpendicular to the optical axis 16 is plotted. In particular, a center position C and a position at an outer perimeter OP are indicated. In FIG. 3A-3C, the center position C coincides with the optical axis 16. Along the vertical axis a relative transmissivity is plotted.

Referring to FIG. 3A and FIG. 4A, the transmissivity of the optical filter device 10 is relatively high in the center C, coinciding with the optical axis 16. Near the optical axis 16, a thickness of the first medium 14 is small. Consequently, a thickness of the second medium 34 is large. Since the first medium 14 holds a light blocking material, the optical path through the first medium 14 determines the transmissivity. Since the optical path through the first medium 14 is short, the transmissivity is high. With an increasing distance from the optical axis 16 the thickness of the first medium 14 increases (FIG. 3A). Consequently, with an increasing distance from the center C towards the outer perimeter OP, the transmissivity decreases (FIG. 4A).

Referring to FIG. 3B and FIG. 4B, the thickness of the first medium near the optical axis 16 is relatively large, resulting in a small transmissivity near the center C. The thickness of the first medium 14 decreases with an increasing distance to the optical axis 16, resulting in an increasing transmissivity with an increasing distance to the center C towards the outer perimeter OP.

Referring to FIG. 3C and FIG. 4C, the thickness of the first medium 14 is equal to the dimension of the container 30 in a direction parallel to the optical axis 16. Consequently, the transmissivity is at a minimum near the optical axis 16. Whether an amount of light may pass near the optical axis 16 depends on the amount of blocking by the light blocking material dissolved in the first medium 14 and a concentration of the light blocking material in the first medium 14. In FIG. 4C it is illustrated that the transmissivity is about zero.

In the embodiment illustrated in FIG. 3A-3C, the optical effect of the optical filter device 10 may be limited to a filter effect provided that the refractive index of the first medium 14 and the refractive index of the second medium 34 are substantially equal. In such a case, the light passing through the optical filter device 10 will not be refracted at the meniscus 18, but will pass straight. Thus, the embodiment of FIG. 3A-3C does not have a lens effect

Above, a number of embodiments of the device according to the present invention have been disclosed. In the illustrated embodiments the transmissivity distribution is symmetrical around the optical axis and/or center of the optical filter device. It is noted that in an optical system, the optical axis of the system does not need to coincide with the center of the optical filter device. Further, the thickness distribution and corresponding transmissivity distribution do not need to be symmetrical, depending on the technique and control means used to control the thickness distribution.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, techniques used in the illustrated embodiments for controlling a shape of a meniscus and thereby the thickness distribution of the medium may be combined in a single embodiment.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily wiredly.

1. Optical filter device (10) comprising
a translucent medium (14) in which a light-blocking material is dissolved, an optical axis (16) extending through the translucent medium, the translucent medium having a thickness distribution substantially parallel to the optical axis;
control means (26, 32) for controlling the thickness distribution of the medium in order to control a transmissivity distribution of the optical filter device.

2. Optical filter device according to claim 1, wherein the light blocking material is a light absorbing material such as a material selected from the group comprising a dye and a pigment.

3. Optical filter device according to claim 1, wherein the light blocking material is a light reflecting material, such as reflecting mica flakes.

4. Optical filter device according to claim 1, wherein the control means comprises an electrode for controlling the thickness distribution using electrowetting.

5. Optical filter device according to claim 1, wherein the translucent medium is held in an at least partly translucent container (22), the container having an opening (24), which opening is covered with an at least partly translucent elastic material (18) and wherein the control means comprise a pump (26) for controlling an amount of the translucent medium in the container.

6. Optical filter device according to claim 1, wherein the optical device comprises a first translucent medium (14) having a light-absorbing material dissolved therein and a second translucent medium (34), the first and the second translucent medium being held in an at least partly translucent container (30), and wherein the control means comprises means for controlling a shape of a meniscus (18) formed between the first and the second translucent medium.

7. Optical filter device according to claim 6, wherein the first and the second translucent medium have a substantially same refractive index.

8. Optical filter device according to claim 6, wherein a perimeter of the meniscus is fixed to an meniscus control element, the meniscus control element being moveable in a direction substantially parallel to the optical axis.

9. Method of reducing vignetting in an optical system, the optical system comprising an optical filter device according to claim 1, the method comprising controlling the thickness distribution of the optical filter device such that the transmissivity of the optical filter device near a center of the optical filter device is lower than the transmissivity near an outer perimeter of the optical filter device.
